(19) United States
(12) Patent Application Publication
(10) Pub. No.: US 2017/0364454 A1
(43) Pub. Date: Dec. 21, 2017

(54) METHOD, APPARATUS, AND COMPUTER PROGRAM STORED IN COMPUTER READABLE MEDIUM FOR READING BLOCK IN DATABASE SYSTEM

(71) Applicant: TmaxData Co., Ltd., Gyeonggi-do (KR)

(72) Inventors: JaeSeok AN, Gyeonggi-do (KR); Jeongin JU, Gyeonggi-do (KR)

(21) Appl. No.: 15/215,929

(22) Filed: Jul. 21, 2016

(30) Foreign Application Priority Data
Jun. 21, 2016 (KR) 10-2016-0077188

(51) Int. Cl. G06F 12/14

(52) U.S. Cl. CPC G06F 12/1475; G06F 2212/1052

(57) ABSTRACT

Provided is a method for reading a block in a database system. Provided is a method for reading data recorded in a persistent storage medium by a first node among a plurality of nodes, including: receiving a reading request for a plurality of blocks among blocks recorded in the persistent storage medium; determining respective master nodes of the plurality of blocks; querying, of the master nodes of the plurality of respective blocks, whether a lock for reading the data recorded in each of the plurality of blocks is required; skipping an operation of obtaining the lock and reading the data, with respect to at least some blocks of which the lock is not required among the plurality of blocks, based on the query result; and reading the data after obtaining the lock with respect to at least some blocks of which the lock is required among the plurality of blocks, based on the query result.

### CROSS-REFERENCE TO RELATED APPLICATIONS

This application claims priority to and the benefit of Korean Patent Application No. 10-2006-0077188 filed in the Korean Intellectual Property Office on Jun. 21, 2016, the entire contents of which are incorporated herein by reference.

### TECHNICAL FIELD

The present disclosure relates to a method for reading data in a database system, and in particular, to a method for efficiently reading data recorded in a persistent storage medium.

### BACKGROUND ART

A database system can collect, store, manage, and analyze data. In recent years, a technology of a mass database system, such as a large quantity of formal or informal data sets and big data processing of extracting a value from the data and analyzing a result has been developed.

In recent years, a database system is constituted by a plurality of nodes. The plurality of nodes can record data in a persistent storage medium and a predetermined node can read the data recorded in the persistent storage medium according to a request by a user.

An operation of the node which is permitted to lock blocks for maintaining matching of the data is required to read the blocks recorded in the persistent storage medium. The lock can limit access of other nodes to the block of the persistent storage medium. The database system can maintain the matching of the data by limiting the access of other nodes to the blocks while the data is read.

When the node reads a large quantity of blocks recorded in the persistent storage medium, the node needs to be permitted to lock the large quantity of blocks. When the large quantity of locks are managed, simultaneous operation execution may be difficult and performance may deteriorate.

Therefore, research into a method in which the node efficiently reads the large quantity of blocks is in progress.

### SUMMARY OF THE INVENTION

The present disclosure has been made in an effort to efficiently read data in a database system.

A first exemplary embodiment of the present disclosure provides a method for reading data recorded in a persistent storage medium by a first node among a plurality of nodes, including: receiving a reading request for a plurality of blocks among blocks recorded in the persistent storage medium; determining respective master nodes of the plurality of blocks; querying, of the master nodes of the plurality of respective blocks, whether a lock for reading the data recorded in each of the plurality of blocks is required; skipping an operation of obtaining the lock and reading the data, with respect to at least some blocks of which the lock is not required among the plurality of blocks, based on the query result; and reading the data after obtaining the lock with respect to at least some blocks of which the lock is required among the plurality of blocks, based on the query result.

A second exemplary embodiment of the present disclosure provides a database recovery program stored in a computer-readable medium and including commands which allow nodes to perform operations, wherein the operations include: an operation of receiving a reading request for a plurality of blocks among blocks recorded in the persistent storage medium; an operation of determining respective master nodes of the plurality of blocks; an operation of querying, of the master nodes of the plurality of respective blocks, whether a lock for reading the data recorded in each of the plurality of blocks is required; an operation of skipping an operation of obtaining the lock and reading the data, with respect to at least some blocks of which the lock is not required among the plurality of blocks, based on the query result; and an operation of reading the data after obtaining the lock with respect to at least some blocks of which the lock is required among the plurality of blocks, based on the query result.

A third exemplary embodiment of the present disclosure provides a database server including: a master node determining unit determining master nodes of a plurality of respective blocks recorded in a persistent storage medium; a lock requirement querying unit querying, of the master nodes of the plurality of respective blocks, whether a lock for reading the data recorded in each of the plurality of blocks is required; and a data reading unit skipping an operation of obtaining the lock and reading the data, with respect to at least some blocks of which the lock is not required among the plurality of blocks and reading the data after obtaining the lock with respect to at least some blocks of which the lock is required among the plurality of blocks, based on the query result.

A fourth exemplary embodiment of the present disclosure provides a database system including a plurality of nodes, wherein a first node includes a master node determining unit determining master nodes of a plurality of respective blocks recorded in a persistent storage medium; a lock requirement querying unit querying, of the master nodes of the plurality of respective blocks, whether a lock for reading the data recorded in each of the plurality of blocks is required; a lock requirement determining unit determining whether the lock is required, with respect to blocks in which the first node is the master node; and a data reading unit skipping an operation of obtaining the lock and reading the data, with respect to at least some blocks of which the lock is not required among the plurality of blocks and reading the data after obtaining the lock with respect to at least some blocks of which the lock is required among the plurality of blocks, based on the query result, and the master nodes of the respective blocks include a lock requirement determining unit determining whether the lock for the blocks is required, based on the lock requirement determining request of the first node.

According to exemplary embodiments of the present disclosure, provided is a method that efficiently reads data recorded in a persistent storage medium.

### BRIEF DESCRIPTION OF THE DRAWINGS

Various aspects are now described with reference to the drawings and like reference numerals are generally used to designate like elements. In the following exemplary embodiments, for description, multiple specific detailed matters are presented to provide general understanding of one or more aspects. However, it will be apparent that the aspect(s) can be executed without the detailed matters. In other examples, known structures and apparatuses are illustrated in a block diagram form in order to facilitate description of the one or more aspects.

FIG. 1 exemplarily illustrates a database system according to an exemplary embodiment of the present disclosure.

FIG. 2 exemplarily illustrates components of the database system according to the exemplary embodiment of the present disclosure.

FIG. 3 exemplarily illustrates a method for reading blocks in a database server according to an exemplary embodiment of the present disclosure.

FIG. 4 exemplarily illustrates a flowchart of a method in which a database server reads blocks according to an exemplary embodiment of the present disclosure.

### DETAILED DESCRIPTION

Various exemplary embodiments will now be described with reference to the drawings and similar reference numerals are used to represent similar elements throughout the drawings. In the specification, various descriptions are presented to provide appreciation of the present disclosure. However, it is apparent that the embodiments can be executed without the specific description. In other examples, known structures and apparatuses are presented in a block diagram form in order to facilitate description of the exemplary embodiments.

“Component”, “module”, “system”, and the like which are terms used in the specification designate a computer-related entity, hardware, firmware, software, or a combination of software and hardware, or execution of software. For example, the component may be a processing process executed on a processor, the processor, an object, an execution thread, a program, and/or a computer, but is not limited thereto. For example, both an application executed in a computing device and the computing device may be the components. One or more components may reside in the processor and/or execution thread and one component may be localized in one computer or distributed among two or more computers. Further, the components may be executed by various computer-readable media having various data structures, which are stored therein. The components may perform communication through local and/or remote processing according to a signal (for example, data through other system and a network such as the Internet through data and/or a signal from one component that interacts with other components in a local system and a distribution system) having one or more data packets, for example.

In the present specification, a database means a system that stores correlated data in formats which a computer may process. The database may keep data and answer a question of a user and the data stored in the database may be changed. The database may store new data and delete and change the existing data.

In the present specification, a node means a device that performs a series of tasks such as an exchange of information or a database update. The transaction may be defined as a basic unit of a task for accomplishing a task required while maintaining integrity of the database.

In the present specification, a node means a device that performs a series of tasks such as an exchange of information or a database update. For example, the node may include a server, a computer, a device including a CPU, and the like and is not limited thereto.

The node may transmit and receive data to and from a persistent storage medium 3000. For example, the node may read the data recorded in the persistent storage medium 3000 and store the read data in a cache module. Further, the node may change the data stored in the cache module and reflect the changed data to the persistent storage medium 3000. In addition, the node may recover the data recorded in the persistent storage medium.

In the present specification, the block may mean a lump of data. For example, the block may include one stable storing data and include a plurality of tables. Further, the data included in one table may be represented by a plurality of blocks.

The block may have various sizes. For example, the block may have sizes of 10 kb, 100 kb, 1 mega byte, 2 mega bytes, 3 mega bytes, 4 mega bytes, and the like but is not limited thereto.

The description of the presented embodiments is provided so that those skilled in the art of the present disclosure can use or implement the present disclosure. Various modifications of the embodiments will be apparent to those skilled in the art and general principles defined herein can be applied to other embodiments without departing from the scope of the present disclosure. Therefore, the present disclosure is not limited to the embodiments presented herein, but should be analyzed within the widest range which is associated with the principles and new features presented herein.

Hereinafter, exemplary embodiments of the present disclosure will be described in detail with reference to the accompanying drawings.

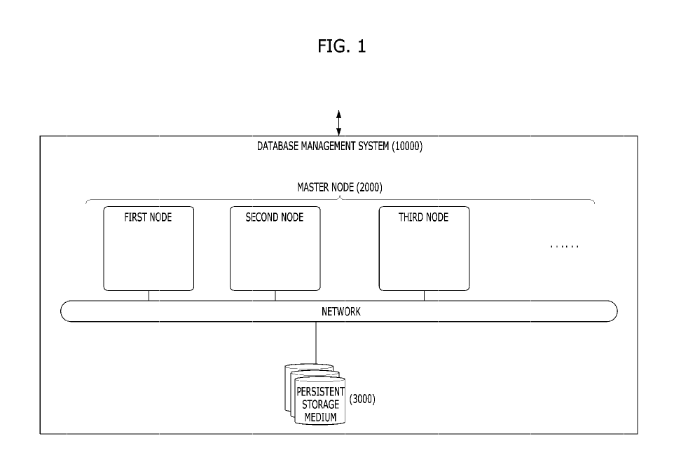

FIG. 1 exemplarily illustrates a database system according to an exemplary embodiment of the present disclosure.

According to an exemplary embodiment of the present disclosure, a database system 10000 may include a plurality of nodes and the plurality of nodes may form a cluster. For example, the plurality of nodes are connected to each other through a predetermined network to form the cluster. In this case, a persistent storage medium 3000 may be shared by the plurality of nodes.

The respective nodes may include predetermined type computer systems or computer devices including a microprocessor, a mainframe computer, a digital single processor, a portable device, and a device controller.

The node may include a memory (not illustrated). The node may perform a database operation by using the memory. For example, when the node performs a transaction, the node may load data from the persistent storage medium 3000 and store the loaded data in at least a part of the memory (not illustrated).

The memory (not illustrated) as a primary storage device which a processor directly accesses, such as a random access memory (RAM) such as a dynamic random access memory (DRAM), a static random access memory (SRAM), or the like may mean a volatile storage device in which when power is turned off, stored information is instantaneously erased, but is not limited thereto. The memory may operate by the processor.

The node and the persistent storage medium 3000 may be connected to each other through the network. The network may include a wired network and a wireless network and is not limited thereto.

The persistent storage medium 3000 may include a non-volatile storage medium which may continuously store predetermined data. For example, the persistent storage medium 3000 may include storage devices based on a flash memory and/or battery-backup memory in addition to a disk, an optical disk, and a magneto-optical storage device and is not limited thereto.

A first node 1000 among the plurality of nodes may receive a reading request of a plurality of blocks recorded in the persistent storage medium from a user. In this case, the user may input the reading request of a large quantity of blocks.

The first node 1000 may determine master nodes 2000 of the respective blocks corresponding to the reading request. Further, the first node 1000 may query to the master nodes 2000 whether a lock is required to read the blocks.

The master nodes 2000 of the blocks may determine whether the lock is required based on the request by the first node 1000. For example, the master node 2000 may determine whether the lock is required based on presence of lock information. The master node 2000 may transmit a determination result of the requirement of the lock to the first node 1000.

The first node 1000 may skip an operation of being permitted to lock blocks of which the lock is not required and read the data, based on the determination result received from the master node 2000. Further, the first node 1000 may be permitted to lock the blocks of which the lock is required and thereafter, read the data, based on the determination result received from the master node 2000.

In the existing database system, when the first node 1000 performs the reading request, the first node 1000 has an operation of holding the lock for the blocks corresponding to the reading request as a required condition. The first node 1000 is permitted to lock the blocks and thereafter, performs the reading operation in order to maintain data matching.

However, when the first node 1000 performs the reading request for the large quantity of blocks, the operation of being permitted to lock all of the large quantity of blocks may cause the memory to be wasted and have a negative influence on the performance of the processor.

According to an exemplary embodiment of the present disclosure, when the first node 1000 queries whether locking the blocks receiving the reading request is required and skips the operation of being permitted to lock the blocks of which the lock is not required and reads the blocks, the quantity of wasted memories may be reduced. Further, the performance of the processor may be improved.

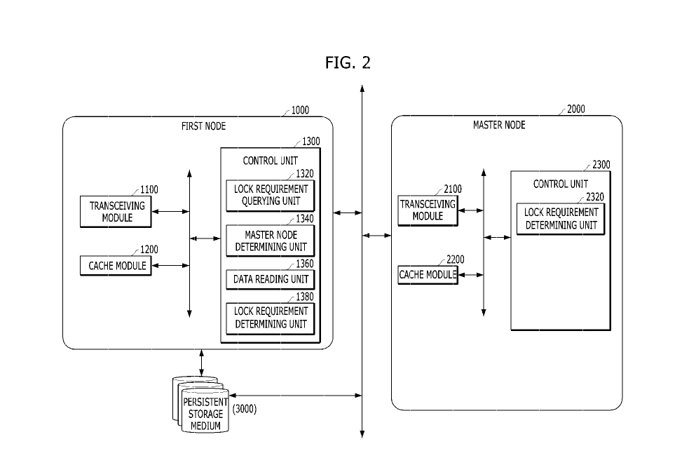

FIG. 2 exemplarily illustrates components of the database system according to the exemplary embodiment of the present disclosure.

According to an exemplary embodiment of the present disclosure, the database system 10000 may include the persistent storage medium 3000 and a plurality of nodes.

The nodes may include a transceiving module 1100, a cache module 1200, and a control unit 1300 and the control unit 1300 may include a lock requirement querying unit 1320, a master node determining unit 1340, a data reading unit 1360, and a lock requirement determining unit 1380.

The persistent storage medium 3000 means, for example, a non-volatile storage medium which may continuously store predetermined data, such as storage devices based on a flash memory and/or a battery-backup memory in addition to a magnetic disk, an optical disk, and a magneto-optical storage device. The persistent storage medium 3000 may communicate with the processors and memories of the nodes through various communication means.

The cache module 1200 may store the data. For example, the cache module 1200 may store the data read from the persistent storage medium 3000. The cache module 1200 may be configured as the non-volatile storage device and is not limited thereto.

The node may include the memory (not illustrated). Herein, the memory as a primary storage device which the processor directly accesses, such as a random access memory (RAM) such as a dynamic random access memory (DRAM), a static random access memory (SRAM), or the like may mean a volatile storage device in which when power is turned off, stored information is instantaneously erased, but is not limited thereto. The memory may operate by the processor.

The transceiving module 1100 may receive from the user data storing, query and index build, a query request, and the like. Further, the transceiving module 1100 may transmit the data and receive the data.

The transceiving module 1100 may receive the reading request of the data for the plurality of blocks. For example, the transceiving module 1100 may receive the reading request for the plurality of blocks among the blocks recorded in the persistent storage medium.

In this case, the transceiving module 1100 may receive reading time information together. The reading time information means information indicating a time of the read data. For example, when the user intends to read the data at a first time, the reading time information may indicate the first time.

The master node determining unit 1340 may determine the master nodes of the plurality of respective blocks. For example, the master node determining unit 1340 may determine the master nodes of the respective blocks corresponding to the reading request among the plurality of blocks.

The master node 2000 means a node that manages the blocks included in the persistent storage medium. For example, the master node 2000 may manage locking of a specific block included in the persistent storage medium 3000. Further, the master node 2000 may possess information on the lock of the specific block.

One master node 2000 may manage one block and manage the plurality of blocks and is not limited thereto.

The master nodes 2000 of the blocks may be predetermined. For example, the master nodes 2000 of the blocks may be predetermined according to the recorded locations in the persistent storage medium and predetermined based on block address information of the respective blocks and are not limited thereto.

The master node determining unit 1340 may determine the master nodes of the plurality of respective blocks by various methods. For example, the master node determining unit 1340 may determine the master node 2000 of a reading candidate block based on the block address information of the plurality of respective blocks.

For example, the master node determining unit 1340 may obtain the block address information of the plurality of respective blocks and inputs the obtained address information of the plurality of blocks in a predetermined function to obtain the result value and determine a node indicated by the result value as the master node 2000 of the block. In this case, the result value may indicate a predetermined master node 2000.

The lock requirement querying unit 1320 of the first node 1000 may query, of the master nodes of the plurality of respective blocks, whether the lock for reading the data recorded in the plurality of blocks is required.

For example, the lock requirement querying unit 1320 may transmit a lock requirement determining request including various information to the master node. Various information may include identification information and reading time information of the block and is not limited thereto. In this case, the lock requirement querying unit 1320 of the first node 1000 may not transmit the lock requirement determining request with respect to blocks in which the first node 1000 is the master node.

The master node 2000 may include a transceiving module 2200, a cache module 2200, and a control unit 2300 and the control unit 2300 may include a lock requirement determining unit 2320. The control unit 2300 of the master node 2000 may be implemented as one process or implemented as a plurality of processors and is not limited thereto.

The transceiving module 2100 of the master node 2000 may receive the lock requirement determining request for at least some blocks among one or more blocks managed by the master node 2000. In this case, the lock requirement determining request may include various information.

Various information may include identification information and reading time information of the block and is not limited thereto.

The lock requirement determining unit 2320 of the master node 2000 may determine whether the lock for reading the blocks by the first node 1000 is required based on the lock requirement determining request received from the first node 1000.

The lock requirement determining unit 2320 may determine whether the lock is required for the first node 1000 to read the blocks based on the received identification information of the block, the received reading time information, or a combination thereof.

According to an exemplary embodiment of the present disclosure, the lock requirement determining unit 2320 may determine whether the lock is required according to whether lock information for the block is present in the master node 2000. For example, when the lock information of the block is not present in the master node 2000, the lock requirement determining unit 2320 may determine that the lock for reading the block by the first node 1000 is not required. Further, when the lock information of the block is present in the master node 2000, the lock requirement determining unit 2320 may determine that the lock for reading the block by the first node 1000 is required.

In this case, the lock requirement determining unit 2320 may determine whether the lock is required by further considering the reading time information. For example, even though the lock information of the block is present in the master node 2000, when the reading time information indicates a previous time of a recent update time on the persistent storage medium of the block, the lock requirement determining unit 2320 may determine that the lock for reading the block is not required.

According to an exemplary embodiment of the present disclosure, the control unit 2300 of the master node 2000 may determine whether to permit the first node to lock the block of which the lock is determined to be required. For example, the control unit 2300 of the master node 2000 may determine whether to permit the first node to lock the block by referring to the possessed lock information. In this case, the lock information may include resource information and lock owner information representing the block and is not limited thereto.

The lock requirement determining unit 2320 of the master node 2000 may determine whether the lock is required with respect to all blocks of which the lock requirement determination is requested from the first node 1000. Further, the transceiving module 2100 of the master node 2000 may transmit a determination result for the lock requirement determination to the first node 1000.

When a plurality of master nodes 2000 is provided, which is requested to determine whether the lock is required, the plurality of master nodes 2000 may perform the lock requirement determination in parallel. Further, the respective transceiving module 2100 of the plurality of master nodes 2000 may transmit the determination result for the lock requirement determination to the first node 1000.

The transceiving module 1100 of the first node 1000 may receive the determination result for the lock requirement from the master node 2000. When the plurality of master nodes 2000 is provided, the first node 1000 may sequentially receive the determination result from the plurality of master nodes 2000 and receive the determination result in parallel and is not limited thereto.

In this case, the first node 1000 may receive the determination result for the blocks in which whether the lock is required is determined from the respective master nodes 2000 per block group.

For example, when the first master node 2000 determines whether the lock for 32 blocks is required, the first node 1000 may receive from the first master node 2000 information on at least one block of which the lock is required among 32 blocks.

When the first master node 2000 determines whether the lock for 32 blocks is required, the first node 1000 may individually receive from the first master node 2000 information on at least one block of which the lock is required among 16 blocks and information on at least one block of which the lock is required among 16 other blocks and the present disclosure is not limited thereto.

The first node 1000 is not limited to the aforementioned example and may receive the determination result for the blocks in which whether the lock is determined to be required from the master nodes 2000 by various means.

The data reading unit 1360 of the first node 1000 may read data of the plurality of blocks based on a query result regarding whether the lock is required.

The data reading unit 1360 may skip the operation of obtaining the lock and read the data with respect to at least some blocks of which the lock is not required among the plurality of blocks.

In this case, the data reading unit 1360 may not store the data in the cache module 1200 and read the data by using the memory (not illustrated).

In this case, the data reading unit 1360 may read data corresponding to the reading time information. For example, the data reading unit 1360 may read data of the time indicated by the reading time information with respect to a block which may include different data according to the time.

The data reading unit 1360 may read the data after obtaining the lock with respect to at least some blocks of which the lock is required among the plurality of blocks.

For example, the data reading unit 1360 may read the data after the master nodes 2000 of the blocks permit the lock with respect to at least some blocks of which the lock is required among the plurality of blocks.

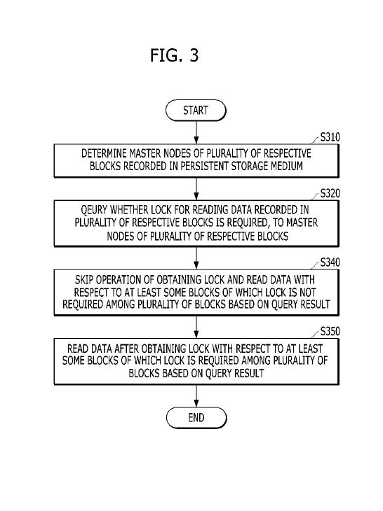

FIG. 3 exemplarily illustrates a method for reading blocks in a database server according to an exemplary embodiment of the present disclosure.

The first node 1000 may receive from the user data storing, querying and index build, a query request, and the like. Further, the first node 1000 may transmit the data and receive the data.

The first node 1000 may receive the reading request of the data for the plurality of blocks. For example, the first node 1000 may receive the reading request for the plurality of blocks among the blocks recorded in the persistent storage medium.

In this case, the first node 1000 may receive the reading time information together. The reading time information means the information indicating the time of the read data. For example, when the user intends to read the data at the first time, the reading time information may indicate the first time.

In step S310, the first node 1000 may determine the master nodes 2000 of the respective blocks.

For example, the first node 1000 may determine the master nodes 2000 of the respective blocks corresponding to the reading request among the plurality of blocks.

The master node 2000 means the node that manages the blocks included in the persistent storage medium. For example, the master node 2000 may manage locking of a specific block included in the persistent storage medium 3000. Further, the master node 2000 may possess information on the lock of the specific block.

One master node 2000 may manage one block and manage the plurality of blocks and is not limited thereto.

The master nodes 2000 of the blocks may be predetermined. For example, the master nodes 2000 of the blocks may be predetermined according to the recorded locations in the persistent storage medium and predetermined based on block address information of the respective blocks and are not limited thereto.

The first node 1000 may determine the master nodes 2000 of the plurality of respective blocks by various methods. For example, the first node 1000 may determine the master node 2000 of a reading candidate block based on the block address information of the plurality of respective blocks.

For example, the first node 1000 may obtain the block address information of the plurality of respective blocks and input the obtained address information of the plurality of blocks in a predetermined function to obtain the result value and determine a node indicated by the result value as the master node 2000 of the block. In this case, the result value may indicate a predetermined master node 2000.

In step S320, the first node 1000 may query, of the master nodes of the plurality of respective blocks, whether the lock for reading the data recorded in the plurality of blocks is required.

For example, the first node 1000 may transmit the lock requirement determining request including various information to the master node. Various information may include identification information and reading time information of the block and is not limited thereto.

The master node 2000 may receive the lock requirement determining request for at least some blocks among one or more blocks managed by the master node 2000. In this case, the lock requirement determining request may include various information.

Various information may include the identification information and reading time information of the block and is not limited thereto.

The master node 2000 may determine whether the lock is required to read the blocks by the first node 1000 based on the lock requirement determining request received from the first node 1000.

The master node 2000 may determine whether the lock is required for the first node 1000 to read the blocks based on the received identification information of the block, the received reading time information, or the combination thereof.

According to an exemplary embodiment of the present disclosure, the master node 2000 may determine whether the lock is required according to whether lock information for the block is present in the master node 2000. For example, when the lock information of the block is not present in the master node 2000, the master node 2000 may determine that the lock for reading the block by the first node 1000 is not required. Further, when the lock information is present in the master node 2000, the master node 2000 may determine that the lock for reading the block by the first node 1000 is required.

In this case, the master node 2000 may determine whether the lock is required by further considering the reading time information. For example, even though the lock information of the block is present in the master node 2000, when the reading time information indicates the previous time of the recent update time on the persistent storage medium of the block, the lock requirement determining unit 2320 may determine that the lock for reading the block is not required.

According to an exemplary embodiment of the present disclosure, the master node 2000 may determine whether to permit the first node 1000 to lock the block of which the lock is determined to be required. For example, the control unit 2300 of the master node 2000 may determine whether to permit the first node to lock the block by referring to the possessed lock information. In this case, the lock information may include the resource information and the lock owner information representing the block and is not limited thereto.

The master node 2000 may determine whether the lock is required with respect to all blocks which are requested to determine whether the lock is required from the first node 1000. Further, the master node 2000 may transmit the determination result for the lock requirement determination to the first node 1000.

When a plurality of master nodes 2000 is provided, of which it is requested to determine whether the lock is required, the plurality of master nodes 2000 may perform the lock requirement determination in parallel. Further, the plurality of respective master nodes 2000 may transmit the determination result for the lock requirement determination to the first node 1000.

The first node 1000 may receive the determination result for the lock requirement determination from the master node 2000. When the plurality of master nodes 2000 is provided, the first node 1000 may sequentially receive the determination result from the plurality of master nodes 2000 and receive the determination result in parallel and is not limited thereto.

In this case, the first node 1000 may receive the determination result for the blocks in which whether the lock is required is determined from the respective master nodes 2000 per block group.

For example, when the first master node 2000 determines whether the lock for 32 blocks is required, the first node 1000 may receive from the first master node 2000 information on at least one block of which the lock is required among 32 blocks.

When the first master node 2000 determines whether the lock for 32 blocks is required, the first node 1000 may individually receive from the first master node 2000 information on at least one block of which the lock is required among 16 blocks and information on at least one block of the lock is required among 16 other blocks and the present disclosure is not limited thereto.

The first node 1000 is not limited to the aforementioned example and may receive the determination result for the blocks in which the lock is determined to be required from the master nodes 2000 by various means.

In steps S330 and S340, the first node may read the data of the plurality of blocks based on the query result regarding whether the lock is required.

The first node 1000 may skip the operation of obtaining the lock and read the data with respect to at least some blocks of which the lock is not required among the plurality of blocks.

In this case, the first node 1000 may not store the data in the cache module 1200 and read the data by using the memory (not illustrated).

In this case, the first node 1000 may read the data corresponding to the reading time information. For example, the first node 1000 may read data at a time indicated by the reading time information regardless of an update time of data included in the block.

The first node 1000 may read the data after obtaining the lock with respect to at least some blocks of which the lock is required among the plurality of blocks.

For example, the first node 1000 may read the data after the master nodes 2000 of the blocks permit the lock with respect to at least some blocks of which the lock is required among the plurality of blocks.

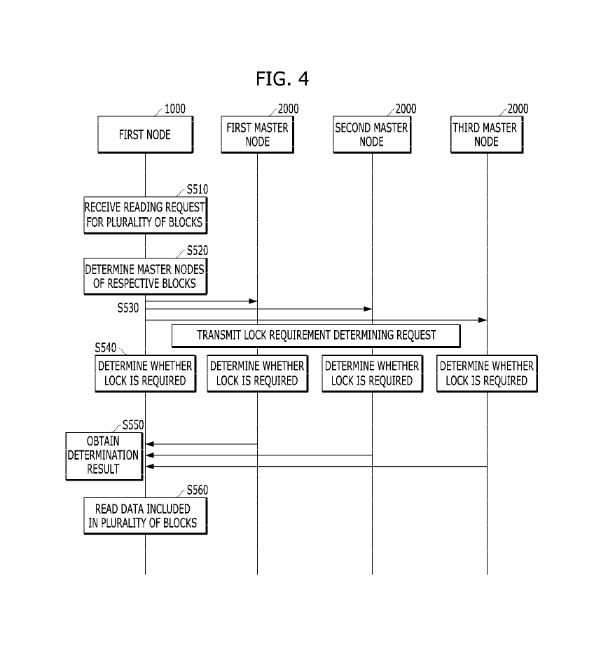

FIG. 4 exemplarily illustrates a flowchart of a method in which a database server reads blocks according to an exemplary embodiment of the present disclosure.

In step S410, the first node 1000 may receive from the user data storing, query and index build, a query request, and the like. Further, the first node 1000 may transmit the data and receive the data.

The first node 1000 may receive the reading request of the data for the plurality of blocks. For example, the first node 1000 may receive the reading request for the plurality of blocks among the blocks recorded in the persistent storage medium.

In this case, the first node 1000 may receive the reading time information together. The reading time information means the information indicating the time of the read data. For example, when the user intends to read the data at the first time, the reading time information may indicate the first time.

In step S420, the first node 1000 may determine the master nodes 2000 of the respective blocks.

For example, the first node 1000 may determine the master nodes 2000 of the respective blocks corresponding to the reading request among the plurality of blocks.

One master node 2000 may manage one block and manage the plurality of blocks and is not limited thereto.

The master nodes 2000 of the blocks may be predetermined. For example, the master nodes 2000 of the blocks may be predetermined according to the recorded locations in the persistent storage medium and predetermined based on block address information of the respective blocks and are not limited thereto.

The first node 1000 may determine the master nodes 2000 of the plurality of respective blocks by various methods. For example, the first node 1000 may determine the master node 2000 of a reading candidate block based on the block address information of the plurality of respective blocks.

For example, the first node 1000 may obtain the block address information of the plurality of respective blocks and input the obtained address information of the plurality of blocks in a predetermined function to obtain the result value and determine a node indicated by the result value as the master node 2000 of the block. In this case, the result value may indicate a predetermined master node 2000.

In step S430, the first node 1000 may transmit to the master nodes of the plurality of respective blocks a request for determining whether the lock for reading the data recorded in the plurality of blocks is required.

For example, the first node 1000 may transmit the lock requirement determining request including various information to the master node 2000 of the respective blocks. Various information may include the identification information and reading time information of the block and is not limited thereto.

In this case, the first node 1000 may not transmit the lock requirement determining request to other nodes with respect to the blocks in which the first node 1000 is the master node 2000.

The lock requirement determining request may include various information. Various information may include the identification information and reading time information of the block and is not limited thereto.

In step S440, the master node 2000 may determine whether the lock of at least some blocks among one or more blocks managed by the master node 2000 is required.

The master node 2000 may determine whether the lock for reading the blocks by the first node 1000 is required based on the lock requirement determining request received from the first node 1000. In this case, the first node 1000 may also be the master node 2000 and the first node 1000 may determine whether the lock is required with respect to the blocks in which the first node 1000 is the master node 2000.

The master node 2000 may determine whether the lock is required for the first node 1000 to read the blocks based on the received identification information of the block, the received reading time information, or the combination thereof.

According to an exemplary embodiment of the present disclosure, the master node 2000 may determine whether the lock is required according to whether lock information for the block is present in the master node 2000. For example, when the lock information of the block is not present in the master node 2000, the master node 2000 may determine that the lock for reading the block by the first node 1000 is not required. Further, when the lock information is present in the master node 2000, the master node 2000 may determine that the lock for reading the block by the first node 1000 is required.

In this case, the master node 2000 may determine whether the lock is required by further considering the reading time information. For example, even though the lock information of the block is present in the master node 2000, when the reading time information indicates a previous time of a recent update time on the persistent storage medium of the block, the lock requirement determining unit 2320 may determine that the lock for reading the block is not required.

According to an exemplary embodiment of the present disclosure, the master node 2000 may determine whether to permit the first node 1000 to lock the block of which the lock is determined to be required. For example, the control unit 2300 of the master node 2000 may determine whether to permit the first node to lock the block by referring to the possessed lock information. In this case, the lock information may include the resource information and the lock owner information representing the block and is not limited thereto.

The master node 2000 may determine whether the lock is required with respect to all blocks which are requested to determine whether the lock is required from the first node 1000. Further, the master node 2000 may transmit the determination result for the lock requirement determination to the first node 1000.

When a plurality of master nodes 2000 is provided, which is requested to determine whether the lock is required, the plurality of master nodes 2000 may perform the lock requirement determination in parallel. Further, the plurality of respective master nodes 2000 may transmit the determination result for the lock requirement determination to the first node 1000.

In step S450, the first node 1000 may receive a determination result regarding whether the lock is required from the master node 2000.

When the plurality of master nodes 2000 is provided, the first node 1000 may sequentially receive the determination result from the plurality of master nodes 2000 and receive the determination result in parallel and is not limited thereto.

In this case, the first node 1000 may receive the determination result for the blocks in which whether the lock is required is determined from the respective master nodes 2000 per block group.

For example, when the first master node 2000 determines whether the lock for 32 blocks is required, the first node 1000 may receive from the first master node 2000 information on at least one block of which of the lock is required among 32 blocks.

When the first master node 2000 determines whether the lock for 32 blocks is required, the first node 1000 may individually receive from the first master node 2000 information on at least one block of which the lock is required among 16 blocks and information on at least one block of which the lock is required among 16 other blocks and the present disclosure is not limited thereto.

The first node 1000 is not limited to the aforementioned example and may receive the determination result for the blocks in which the lock is determined to be required from the master nodes 2000 by various means.

In step S460, the first node may read the data of the plurality of blocks based on the query result regarding whether the lock is required.

The first node 1000 may skip the operation of obtaining the lock and read the data with respect to at least some blocks of which the lock is not required among the plurality of blocks.

In this case, the first node 1000 may not store the data in the cache module 1200 and read the data by using the memory (not illustrated).

In this case, the first node 1000 may read the data corresponding to the reading time information. For example, the first node 1000 may read data at a time indicated by the reading time information regardless of an update time of data included in the block.

The first node 1000 may read the data after obtaining the lock with respect to at least some blocks of which the lock is required among the plurality of blocks.

For example, the first node 1000 may read the data after the master nodes 2000 of the blocks permit the lock with respect to at least some blocks of which the lock is required among the plurality of blocks.

The embodiment of the present disclosure may be implemented even in the form of a recording medium including a command executable by a computer such as a program module executed by the computer. A computer readable medium may be a predetermined available medium accessible by the computer or includes all of volatile and non-volatile media and removable and irremovable media. Further, the computer readable recording medium may include a temporary recording medium and a non-temporary recording medium.

The computer readable medium may include both a computer storage medium and a communication medium. The computer storage medium includes all of the volatile and non-volatile and removable and irremovable media implemented by a predetermined method or technology for storing information such as a computer readable command, a data structure, a program module, or other data. The communication medium typically includes the computer readable command, the data structure, the program module, or other data of a modulated data signal such as a carrier, or other transmission mechanisms and includes a predetermined information transfer medium.

The description of the present disclosure is used as an example and those skilled in the art will understand that the present disclosure can be easily modified to other detailed forms without changing the technical spirit or an essential characteristic of the present disclosure. Therefore, it should be appreciated that the exemplary embodiments described above are exemplifiable in all aspects and not limitative. For example, each component described as a single type may be implemented to be distributed and similarly, components described to be distributed may also be implemented in a combined form.

The protection scope of the present disclosure is described by the appended claims to be described below rather than the detailed description and it should be appreciated that meanings and ranges of the claims and all changes and modified forms derived from the equivalent thereto are included in the scope of the present disclosure.

What is claimed is:

1. A method for reading data recorded in a persistent storage medium by a first node among a plurality of nodes, the method comprising:
receiving a reading request for a plurality of blocks among blocks recorded in the persistent storage medium;
determining respective master nodes of the plurality of blocks;
querying, of the master nodes of the plurality of respective blocks, whether a lock for reading the data recorded in each of the plurality of blocks is required;
skipping an operation of obtaining the lock and reading the data, with respect to at least some blocks of which the lock is not required among the plurality of blocks, based on the query result; and
reading the data after obtaining the lock with respect to at least some blocks of which the lock is required among the plurality of blocks, based on the query result.

2. The method of claim 1, wherein the querying includes:
transmitting a lock requirement determining request including identification information and reading time information of the block to the master nodes of the plurality of respective blocks—the master nodes of the respective blocks determining whether the lock is required based on whether lock information for the blocks is present in the master node; and
receiving a result of determining whether the lock is required from the master nodes of the plurality of respective blocks.

3. The method of claim 2, wherein the master nodes of the plurality of respective blocks
determine that the lock for reading the blocks is not required when the lock information for the blocks is not present in the master node, and
determine that the lock for reading the blocks is required when the lock information for the blocks is present in the master node.

4. The method of claim 2, wherein the master node determines whether the lock is required by further considering whether the reading time information indicates a previous time of a recent update time on the persistent storage medium of the block.

5. The method of claim 2, wherein the master node determines whether to permit the first node to lock at least some blocks of which the lock is required among the plurality of blocks based on the result of determining whether the lock is required.

6. The method of claim 1, wherein in the skipping of the operation of obtaining the lock and the reading of the data, data at the time indicated by the reading time information is read.

7. A database recovery program stored in a computer-readable medium and including commands which allow nodes to perform operations, wherein the operations comprise:
an operation of receiving a reading request for a plurality of blocks among blocks recorded in the persistent storage medium;
an operation of determining respective master nodes of the plurality of blocks;
an operation of querying, of the master nodes of the plurality of respective blocks, whether a lock for reading the data recorded in each of the plurality of blocks is required;
an operation of skipping an operation of obtaining the lock and reading the data, with respect to at least some blocks of which the lock is not required among the plurality of blocks, based on the query result; and
an operation of reading the data after obtaining the lock with respect to at least some blocks of which the lock is required among the plurality of blocks, based on the query result.

8. A database server comprising:
a master node determining unit determining master nodes of a plurality of respective blocks recorded in a persistent storage medium;
a lock requirement querying unit querying, of the master nodes of the plurality of respective blocks, whether a lock for reading the data recorded in each of the plurality of blocks is required; and
a data reading unit skipping an operation of obtaining the lock and reading the data, with respect to at least some blocks of which the lock is not required among the plurality of blocks and reading the data after obtaining the lock with respect to at least some blocks of which the lock is required among the plurality of blocks, based on the query result.

9. A database system including a plurality of nodes, wherein a first node includes:
a master node determining unit determining master nodes of a plurality of respective blocks recorded in a persistent storage medium;
a lock requirement querying unit querying, of the master nodes of the plurality of respective blocks, whether a lock for reading the data recorded in each of the plurality of blocks is required;
a lock requirement determining unit determining whether the lock is required, with respect to blocks in which the first node is the master node; and
a data reading unit skipping an operation of obtaining the lock and reading the data, with respect to at least some blocks of which the lock is not required among the plurality of blocks and reading the data after obtaining the lock with respect to at least some blocks of which the lock is required among the plurality of blocks, based on the query result, a
wherein the master nodes of the respective blocks includes:
a lock requirement determining unit determining whether the lock for the blocks is required, based on the lock requirement determining request of the first node.
